(19) United States
(12) Patent Application Publication
(10) Pub. No.: US 2018/0370287 A1
(43) Pub. Date: Dec. 27, 2018

(54) Tire Tread For A Heavy Civil Engineering Vehicle

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Philippe MANSUY, Clermont-Ferrand Cedex 9 (FR); Antoine PERRIOT, Clermont-Ferrand (FR)

(21) Appl. No.: 15/736,977

(22) PCT Filed: Jun. 14, 2016
(86) PCT No.: PCT/EP2016/063551

§ 371 Date: Dec. 15, 2017

(30) Foreign Application Priority Data
Jun. 17, 2015 (FR) 1555522

(51) Int. Cl. B60C 11/00; B60C 9/00; B60C 9/18

(52) U.S. Cl. CPC B60C 11/0008; B60C 9/0007; B60C 9/18; B60C 2200/065; B60C 2011/0025; B60C 2011/0033; B60C 11/005

(57) ABSTRACT

Tire tread is made up of a radial superposition of a first portion (21) and of a second portion (22) radially on the outside of the first portion (21). The first portion (21) is made up of a radial superposition of N layers C₁ᵢ, each layer C₁ᵢ having a radial thickness E₁ᵢ that is substantially constant and being made up of a polymer material M₁ᵢ having a dynamic shear modulus G₁ᵢ. The second portion (22) is made up of a single layer C₂ having a radial thickness E₂ that is substantially constant and being made up of a polymer material M₂ having a dynamic shear modulus G₂. The following relationships are simultaneously satisfied:

1/(E₁/G₁+E₂/G₂)>G₀/(E₁+E₂), where E₁=Σᵢ₌₁^{N}E₁ᵢ, G₁=E₁/(Σᵢ₌₁^{N}E₁ᵢ/G₁ᵢ) where E₁ᵢ, E₁, E₂ in mm, G₁ᵢ, G₁, G₂ in MPa and where 1 MPa≤G₀>1.8 MPa a.

G₁<G₀ b.

E₁≥E₁min=25 mm c.

G₂>G₀>G₁ d.

E₂≤E₂max=70 mm e.

1/(Σᵢ₌₁^{j}E₁ᵢ/G₁ᵢ)<1/(Σᵢ₌ⱼ₊₁^{N}E₁ᵢ/G₁ᵢ) for 1≤j≤N-1 f.

The subject of the present invention is a radial tire, intended to be fitted to a heavy vehicle of civil engineering type, and the invention relates more particularly to the tread thereof.

According to the classification of the European Tire and Rim Technical Organisation or ETRTO standard, a radial tire for a heavy vehicle of civil engineering type is intended to be mounted on a rim with a diameter of at least 25 inches. Without being restricted to this type of product, the invention is described in the case of a large sized radial tire intended to be mounted on a vehicle of dumper type, intended for transporting materials extracted from quarries or open-cast mines. What is meant by a large sized radial tire is a tire intended to be mounted on a rim with a diameter of at least 49 inches and which may be as much as 57 inches or even 63 inches.

On sites at which materials, such as ores or coal, are extracted, the use of a vehicle of dumper type consists, in simplified form, of an alternation of laden outbound cycles and of unladen return cycles. In a laden outbound cycle, the laden vehicle transports the extracted materials, mainly uphill, from the loading zones at the bottom of the mine, or the bottom of the pit, to unloading zones. In an unladen return cycle, the empty vehicle returns, mainly downhill, towards the loading zones at the bottom of the mine.

Given the small dimensions of the loading and unloading zones, the vehicles are forced to perform manoeuvres for loading or unloading, particularly half-circle turns on paths with very small radii typically of between 12 m and 15 m, placing a great deal of load on the tires.

Furthermore, the tracks on which the vehicles run are made up of materials generally taken from the mine, for example compacted crushed rocks which are regularly damped down in order to guarantee the integrity of the wearing layer of the track as the vehicles pass over it.

The load applied to the tire is dependent both on its position on the vehicle and on the duty cycle of the vehicle. By way of example, for a gradient of approximately 10%, during a laden outbound uphill cycle, one third of the total load of the vehicle is applied to the front axle, generally fitted with two tires fitted singly, and two thirds of the total load of the vehicle are applied to the rear axle, generally fitted with four tires, mounted in twinned pairs. During the unladen downhill return cycle, for a gradient of approximately 10%, half of the total load of the vehicle is applied to the front axle and half of the total load of the vehicle is applied to the rear axle. The tires fitted to mining dumpers are, as a general rule, fitted singly on the front axle of the vehicle for the first third of their life, then changed around and fitted as part of a twinned pair to the rear axle for the remaining two thirds of their life.

From an economic standpoint, transporting the materials extracted may represent up to 50% of the operating costs of the mine, and the contribution that the tires make to the costs of transport is significant. As a result, limiting the rate of wear of the tires is a key contributor to reducing the operating costs. From the tire manufacturer standpoint, developing technical solutions that make it possible to reduce the rate of wear is therefore an important strategic objective.

Tires for use in the mines are subjected to high mechanical stress loadings, both locally, when running on tracks covered by indenting bodies consisting of stones the average size of which is typically between 1 inch and 2.5 inches, and at an overall level, when running with significant turning moment over gradients of between 8.5% or 10% and during half-circle turns for the loading and unloading manoeuvres. These mechanical stress loadings lead to relatively rapid tire wear.

The technical solutions envisioned to date for reducing the rate of wear relate essentially to the design of the tread pattern, to the choice of the materials from which to make the tread, generally elastomer compounds, and to optimizing the crown reinforcement radially on the inside of the tread. For example, in the field of the tread pattern, patent WO 2004085175 proposes the use of a tread, the tread pattern elements of which exhibit an inclination of the front and rear faces that are differentiated and variable across the width of the tread so as to generate coupling forces that are dependent on the applied load, and thus modify the operating point of the tire in terms of slip, thereby limiting wearing phenomena.

Since a tire has a geometry that exhibits symmetry of revolution about an axis of rotation, its geometry is usually described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively. By convention, the expressions “radially inner or, respectively, radially outer” mean “closer to or, respectively, further away from the axis of rotation of the tire”. “Axially inside or, respectively, axially outside” means “closer to or, respectively, further away from the equatorial plane of the tire”, the equatorial plane of the tire being the plane passing through the middle of the tread surface of the tire and perpendicular to the axis of rotation of the tire.

The inventors have set themselves the objective of reducing the wear rate of the tread of a radial tire for a heavy vehicle of civil engineering type subjected to high mechanical stress loadings induced by the aforementioned mining usage.

This objective has been achieved, according to the invention, by a tire for a heavy vehicle of civil engineering type comprising a tread, intended to come into contact with the ground,
the tread having an axial width L and being made up of a radial superposition of a first portion and of a second portion radially on the outside of the first portion,
the first portion being made up of a radial superposition of N layers C₁ᵢ, i varying from 1 to N,
each layer C₁ᵢ having a radial thickness E₁ᵢ, measured in an equatorial plane of the tire, that is substantially constant over at least 80% of the axial width L of the tread, and being made up of a polymer material M₁ᵢ having a dynamic shear modulus G₁ᵢ, measured for a frequency equal to 10 Hz, a deformation equal to 50% of the peak-to-peak deformation amplitude and a temperature equal to 60° C.,
the second portion being made up of a single layer C₂,
the layer C₂ having a radial thickness E₂, measured in the equatorial plane of the tire, that is substantially constant over at least 80% of the axial width L of the tread, and being made up of a polymer material M₂ having a dynamic shear modulus G₂, measured for a frequency equal to 10 Hz, a deformation equal to 50% of the peak-to-peak deformation amplitude and a temperature equal to 60° C.,
the following relationships being simultaneously satisfied:

1/(E₁/G₁+E₂/G₂)>G₀/(E₁+E₂), where E₁=Σᵢ₌₁^{N}E₁ᵢ, G₁=E₁/(Σᵢ₌₁^{N}E₁ᵢ/G₁ᵢ) where E₁ᵢ, E₁, E₂ in mm, G₁ᵢ, G₁, G₂ in MPa and where 1 MPa≤G₀≤1.8 MPa a.

G₁<G₀ b.

E₁≥E₁min=25 mm c.

G₂>G₀>G₁ d.

E₂≤E₂max=70 mm e.

1/(Σᵢ₌₁^{j}E₁ᵢ/G₁ᵢ)<1/(Σᵢ₌ⱼ₊₁^{N}E₁ᵢG₁ᵢ) for 1≤j≤N-1 f.

The tire tread of the invention is the wearing portion of the tire and is intended to come into contact with the ground which, in the context of the invention, is covered with indenting bodies consisting of stones the maximum dimension of which is at least equal to 1 inch and at most equal to 2.5 inches. The passage of the tire over these indenting bodies generates significant local deformations in the tread.

The tire tread of the invention has an axial width L, measured parallel to the axis of rotation of the tire between the axial extremities of the tread.

The tread is made up of a radial superposition of a first portion and of a second portion radially on the outside of the first portion.

The first portion of the tread is made up of a radial superposition of N layers C₁ᵢ, i varying from 1 to N: this is therefore a multilayer portion, where N is usually at most equal to 3. The first radially innermost layer C₁ᵢ of the first portion is in contact, via a radially interior face, either directly with a crown reinforcement or with an intermediate layer made of polymer material which is itself in contact with the crown reinforcement. The radially outermost Nth layer C_{1N} of the first portion is in contact, via a radially exterior face, with a radially interior face of the layer C₂ of the second portion radially on the outside of the first portion.

Each layer C₁ᵢ for i varying from 1 to N has a radial thickness E₁ᵢ, measured in an equatorial plane of the tire, that is substantially constant over at least 80% of the axial width L of the tread, and is made up of a polymer material M₁ᵢ having a dynamic shear modulus G₁ᵢ, measured for a frequency equal to 10 Hz, a deformation equal to 50% of the peak-to-peak deformation amplitude and a temperature equal to 60° C. The polymer materials are all different from one another and therefore have different dynamic modulus values G₁ᵢ.

The second tread portion is made up of a single layer C₂: this is therefore a monolayer portion. The layer C₂ is in contact, via a radially interior face, with the radially exterior face of the radially outermost Nth layer C_{1N} of the first portion and is intended to come into contact with the ground via a radially exterior face.

The layer C₂ has a radial thickness E₂, measured in the equatorial plane of the tire, that is substantially constant over at least 80% of the axial width L of the tread, and is made up of a polymer material M₂ having a dynamic shear modulus G₂, measured for a frequency equal to 10 Hz, a deformation equal to 50% of the peak-to-peak deformation amplitude and a temperature equal to 60° C.

A radial thickness of a layer is a distance measured, in the radial direction, between the respectively radially interior and radially exterior faces of the layer. This thickness is measured in the equatorial plane of the tire, which passes through the middle of the tread and is perpendicular to the axis of rotation of the tire. This thickness is measured on a new tire, which means to say a tire which has not run, and is therefore unworn. What is meant by radial thickness that is substantially constant is a thickness comprised within a range of + or −5% of a mean thickness and over at least 80% of the axial width L of the tread.

A dynamic shear modulus is measured on a viscosity analyser of Metravib VA4000 type according to Standard ASTM D 5992-96. The response of a sample of vulcanized polymer material in the form of a cylindrical test specimen with a thickness of 4 mm and with a cross section of 400 mm², subjected to a simple alternating sinusoidal shear stress, at a frequency of 10 Hz, at a temperature of 60° C., at a deformation amplitude sweep from 0.1% to 45% (outward cycle) and then from 45% to 0.1% (return cycle), is recorded. The dynamic shear modulus is thus measured for a frequency of 10 Hz, a deformation equal to 50% of the peak-to-peak deformation amplitude and a temperature equal to 60° C.

According to the invention, six inequalities combining the radial thicknesses and/or the dynamic shear modulus values of the layers that make up the first and second tread portions need to be satisfied.

The first inequality 1/(E₁/G₁+E₂/G₂)>G₀/(E₁+E₂), where E₁=Σᵢ₌₁^{N}E₁ᵢ, G₁=E₁/(Σᵢ₌₁^{N}E₁ᵢ/G₁ᵢ) where E₁ᵢ, E₁, E₂ in mm, G₁ᵢ, G₁, G₂ in MPa and where 1 MPa≤G₀≤1.8 MPa, means that the stiffness of a tread according to the invention, made up of a first portion, itself made up of the radial superposition of N layers C₁ᵢ, having respective radial thicknesses E₁ᵢ and being made up of polymer materials M₁ᵢ having respective shear modulus values G₁ᵢ, and an exterior second radial portion, made up of a single layer C₂, having a radial thickness E₂ and being made up of a polymer material M₂ having a respective shear modulus G₂, needs to be higher than the stiffness of a tread of the prior art, made up of an equivalent single layer having a radial thickness equal to the sum of the radial thicknesses of all the constituent layers of the first and second portions respectively, the said equivalent layer being made up of a polymer material having a dynamic shear modulus G₀. The reference dynamic shear modulus G₀, in the field of tires for heavy vehicles of the civil engineering type, is usually at least equal to 1 MPa and at most equal to 1.8 MPa.

In order to simplify the writing of the inequality, the equivalent radial thickness E₁ and the equivalent dynamic shear modulus G₁ for the first portion, likened to a single equivalent layer C₁, are introduced. By definition, the equivalent radial thickness E₁ of the first portion is equal to the sum of the respective radial thicknesses E₁ᵢ of the layers C₁ᵢ. By definition also, the equivalent flexibility E₁/G₁ of the first portion, which is the inverse of the equivalent stiffness G₁/E₁, is equal to the sum of the respective flexibilities E₁ᵢ/G₁ᵢ, of the layers C₁ᵢ, which gives the expression for the equivalent dynamic shear modulus G₁ of the first portion.

This first inequality expresses the fact that, on the new tire, which means to say at the start of its life, when it is mounted on the front axle of the vehicle, the multilayer tread of a tire according to the invention needs to be more rigid than the monolayer tread of a tire of the prior art. This is because the tread of a new tire, at the start of its life on a front axle, wears predominantly under the force imposed. Now, locally, the force applied to the tread is the product of the stiffness of the tread and the local rate of slip to which wear is proportional. As a result, for a force imposed, when the stiffness of the tread increases, the local rate of slip, and therefore wear, decrease. Thus, at the start of life, the multilayer tread of the invention, which is more stiff, will wear less quickly than the monolayer tread of the prior art.

The second inequality G₁<G₀ means that the equivalent dynamic shear modulus G₁ of the first portion needs to be lower than the dynamic shear modulus G₀ of the single polymer material of which the tread of a tire of the prior art is made, measured under the same conditions. If the residual radial thickness of the tread, at the end of life of the tire on a rear axle and measured from the crown reinforcement, is termed Eᵣ, the second inequality can also be written G₁/Eᵣ<G₀/Eᵣ. For the tire of the invention, Eᵣ corresponds to the residual radial thickness of the radially inner first portion of the partially worn tread, part of the radially outermost layers C₁ᵢ having been completely worn away. This new relationship expresses the fact that the stiffness of the multilayer tread of the invention at the end of life G₁/Eᵣ needs to be lower than that of the tread of the prior art G₀/Eᵣ. The tread of a worn tire, at the end of its life on a rear axle, wears predominantly under the deformation imposed. Now, the local slip rate is the ratio of the local force, applied to the tread, and the stiffness of the tread. Thus, when the stiffness of the tread decreases, the local force decreases. Because wear is an increasing function of local force, when the stiffness of the tread decreases, the wear, which varies in the same direction as the local force, decreases. As a result, the tread of the invention, which is less stiff, will wear less quickly than the tread of the prior art.

Thus, the first two inequalities express the fact that tread wear of a tire according to the invention is not as rapid as that of a tire of the prior art, at the start of life and at the end of life, namely throughout the life of the tire.

The third inequality E₁≤E₁min=25 mm means that the equivalent radial thickness E₁ of the radially interior first portion needs at least to be equal to a minimum value E₁min, equal to 25 mm and corresponding to the depth of influence of the indenting bodies that usually cover the tracks run on. In other words, the radially interior first portion needs to be thick enough that it has sufficient flexibility to have a cushioning effect able to envelop the indenting body.

The fourth inequality G₂>G₀>G₁ means that the dynamic shear modulus G₂ of the second portion needs to be greater both than the reference dynamic shear modulus G₀ and than the equivalent dynamic shear modulus G₁ of the first portion, namely that there needs to be a decreasing gradient in dynamic shear modulus values when passing from the second portion to the first portion.

The fifth inequality E₂≤E₂max=70 mm means that the radial thickness E₂ of the single layer C₂ of the radially exterior second portion needs at most to be equal to a maximum value E₂max, equal to 70 mm and corresponding to the limiting radial thickness beyond which the running of the tire over the indenting bodies no longer has an impact on the deformations of the radially inner layers of the first portion. In other words, in order to allow the radially interior first portion to have the cushioning effect, and in order to guarantee that the radially exterior second portion intended to come into contact with the indenting bodies has sufficient stiffness, this radially exterior second portion should not be too thick.

The sixth inequality 1/(Σᵢ₌₁^{j}E₁ᵢ/G₁ᵢ)<1/(Σᵢ₌ⱼ₊₁^{N}E₁ᵢ/G₁ᵢ), for 1≤j≤N-1, means that, within the first portion, the stiffness of the assembly made up of the radially innermost j layers C₁ⱼ needs to be less than the stiffness of the assembly made up of the radially outermost (N-j-1) layers. There is thus a gradient of decreasing stiffnesses, for the layers of the first portion, when passing from the radially outermost layers to the radially innermost layers. Thus, the radially innermost radially layers which are the least stiff and therefore the most flexible act as cushions towards the radially outermost layers.

The invention allows action simultaneously at local level on the stress loadings imposed on the tread and at overall level on the operating domain of the tire during the course of its life on the vehicle, mounted successively on the front axle and then on the rear axle, with a view to improving the wearing performance of the tire.

Advantageously, the relationship G₁>0.5*G₀ is satisfied. Thus the equivalent dynamic shear modulus G₁ of the radially interior first portion needs to be greater than 0.5 times the dynamic shear modulus G₀ of the single polymer material of which the tread of a tire of the prior art is made, measured under the same conditions. This relationship indicates that, in order to ensure that the first inequality defined hereinabove is sastisfied, and that the tread has sufficient overall stiffness, the equivalent dynamic shear modulus G₁ must not be too low.

Advantageously too, the relationship G₂<3*G₁ is satisfied. The ratio between the dynamic shear modulus G₂ of the second portion and the equivalent dynamic shear modulus G₁ of the first portion must not be too high, and in practice must be lower than 3, in order to guarantee a significant cushioning effect of the radially interior layers of the first portion.

It is also advantageous for the relationship E₂≥E₂min=25 mm to be satisfied. In other words, the radially exterior second portion needs to be thick enough with, in practice, a radial thickness E₂ at least equal to 25 mm, to guarantee sufficient stiffness of this radially exterior second portion, at the start of life, when the tire is mounted on the front axle of the vehicle.

According to another advantageous embodiment of the invention, the relationship 0.3<E₁/(E₁+E₂)<0.7 is satisfied. This relationship characterizes the positioning of the geometric interface of contact between the radially interior first portion and the radially exterior second portion within a range of values, making it possible to have the desired change in overall stiffness of the tire tread during the course of its life on the vehicle, mounted in succession on the front axle and on the rear axle. This condition guarantees a tread that is relatively stiff in the first third of the life of the tire mounted on the front axle and a tread that is relatively flexible in the final two thirds of the life of the tire mounted on the rear axle.

According to one particular embodiment, the relationship G₀=1.3 MPa is satisfied. The dynamic shear modulus G₀ of the single polymer material of which the tread of a tire of the prior art, considered as reference in the invention, is made is equal to 1.3 MPa. This value is a typical dynamic shear value for an elastomer compound of a monolayer tread of the prior art.

According to one preferred embodiment of the invention, each polymer material M₁ᵢ of which each layer C₁ᵢ of the first portion is made is an elastomer compound, which means to say a polymer material comprising a diene elastomer of natural or synthetic rubber type obtained by compounding the various components of the material. This is the type of material most often used in the field of tires.

As a preference also, the polymer material M2 of which the layer C₂ of the second portion is made is an elastomer compound.

Usually, the various polymer materials of the various layers that make up the tread, namely both the first portion and the second portion, are all of them elastomer compounds.

Generally, the first portion is made up of a radial superposition of N layers C₁ᵢ, where N is at most equal to 3, preferably at most equal to 2. In other words, for preference, the tread is made up of a radial superposition of at most 3 layers.

More preferably still, the first portion is made up of a single layer C₁ᵢ. In other words, the tread is made up of a radial superposition of 2 layers, which is the most usual configuration of the prior art.

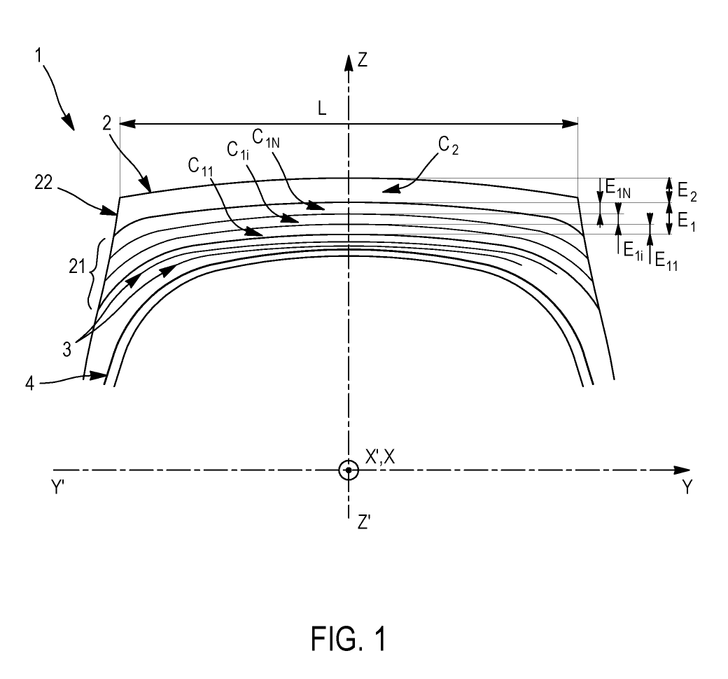

The features of the invention are illustrated by the schematic FIGS. 1, 2, 3A, 3B, 4A, 4B, 5 and 6, which are not drawn to scale.

FIG. 1 depicts a meridian section through the crown of a tire 1 for a heavy vehicle of civil engineering type according to the invention, comprising a tread 2, intended to come into contact with the ground. The directions XX′, YY′ and ZZ′ are respectively the circumferential, axial and radial directions of the tire. The plane XZ is the equatorial plane of the tire. The tread, having an axial width L, is made up of a radial superposition of a first portion 21 and of a second portion 22 radially on the outside of the first portion 21.

The first portion 21 is made up of a radial superposition of N layers C₁ᵢ, i varying from 1 to N , each layer C₁ᵢ having a radial thickness E₁ᵢ, measured in an equatorial plane XZ of the tire, that is substantially constant over at least 80% of the axial width L of the tread 2, and being made up of a polymer material M₁ᵢ having a dynamic shear modulus G₁ᵢ, measured for a frequency equal to 10 Hz, a deformation equal to 50% of the peak-to-peak deformation amplitude and a temperature equal to 60° C. The multilayer first portion 21 can be likened to a monolayer portion of which the equivalent radial thickness E₁ is equal to the sum of the respective radial thicknesses E₁ᵢ of the layers C₁ᵢ, and the equivalent flexibility E₁/G₁ of the first portion of which is equal to the sum of the respective flexibilities E₁ᵢ/G₁ᵢ of the layers C₁ᵢ.

The second portion 22 is made up of a single layer C₂, the layer C₂ having a radial thickness E₂, measured in the equatorial plane XZ of the tire, that is substantially constant over at least 80% of the axial width L of the tread 2, and being made up of a polymer material M₂ having a dynamic shear modulus G₂, measured for a frequency equal to 10 Hz, a deformation equal to 50% of the peak-to-peak deformation amplitude and a temperature equal to 60° C.

Depicted radially on the inside of the radially interior first portion 21 is the crown reinforcement 3 comprising two crown layers containing metal reinforcers. Depicted radially on the inside of the crown reinforcement 3 is the carcass reinforcement 4 comprising a carcass layer containing metal reinforcers.

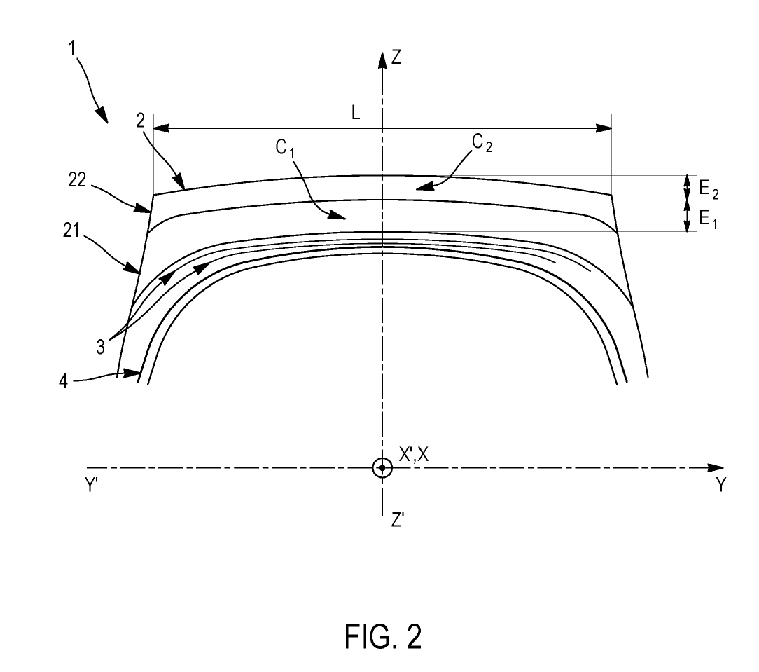

FIG. 2 depicts a meridian section through the crown of a tire 1 for a heavy vehicle of civil engineering type according to a preferred embodiment of the invention, comprising a tread 2, intended to come into contact with the ground. According to this preferred embodiment, the first portion 21 is made up of a single layer C₁. In this particular instance, the tread is made up of the radial superposition of two layers, the first and second portions being monolayers: the tread is said to be bilayer.

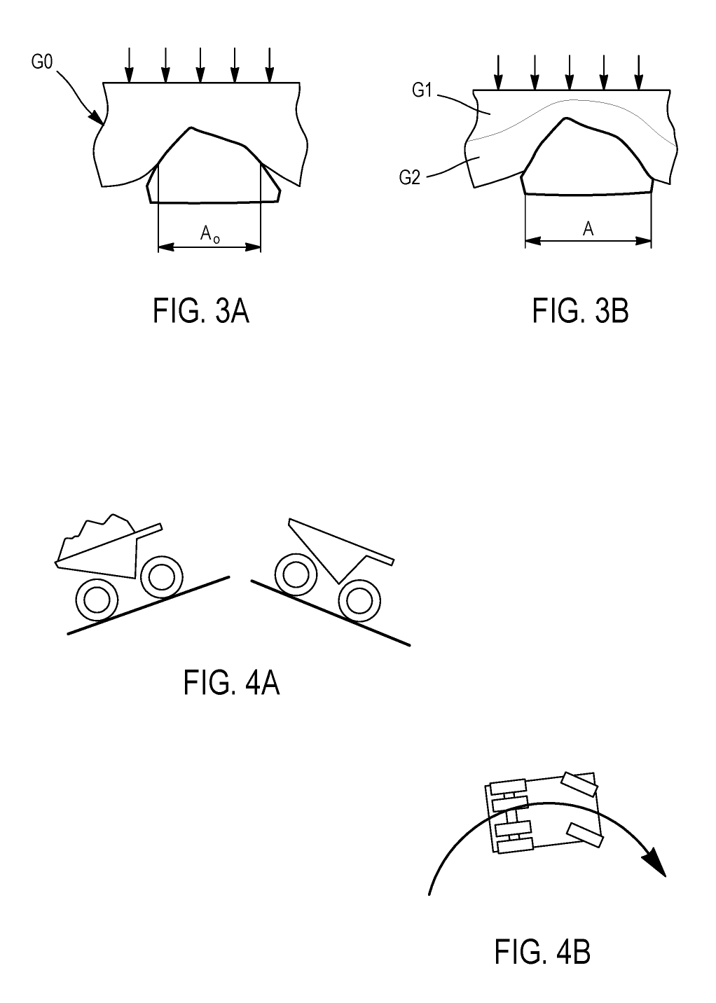

FIGS. 3A and 3B depict the local deformation of the tread when passing over an indenting body, for a tire of the prior art with a monolayer tread and a tire according to the invention comprising a bilayer tread, respectively. For the tire of the prior art, the monolayer tread is made up of an elastomer compound having a dynamic shear modulus G₀, measured for a frequency equal to 10 Hz, a deformation equal to 50% of the peak-to-peak deformation amplitude and a temperature equal to 60° C. and its local deformation has a length projected onto the ground equal to A₀. For the tire according to the invention, the bilayer tread is made up of a radially interior first layer, made up of a first elastomer compound having a dynamic shear modulus G₁, measured for a frequency equal to 10 Hz, a deformation equal to 50% of the peak-to-peak deformation amplitude and a temperature equal to 60° C., and of a radially interior second layer, made up of a second elastomer compound having a dynamic shear modulus G₂, measured under the same conditions. In this case, the local deformation of the tread has a length projected onto the ground A greater than A₀. The bilayer tread of the invention envelops the inventing body more than the monolayer tread, because of the cushioning effect of the radially interior first layer which is not as stiff as the radially exterior second layer.

FIGS. 4A and 4B respectively depict a laden uphill outbound cycle and an unladen downhill return cycle of a dumper, as well as a half-circle turning manoeuvre performed by a dumper.

For operation uphill and downhill, as illustrated in FIG. 4A, the gradient is, by way of example, between 8.5% and 10%. For a 400-tonne dumper, laden and moving uphill, the load applied to a tire mounted at the front or at the rear is equal to 67 t, and the force Fₓ applied to a tire mounted at the rear is equal to 10,000 daN. For a 400-tonne dumper, unladen and moving downhill, the load applied to a tire mounted at the front is equal to 60 t, and the load applied to a tire mounted at the rear is equal to 30 t. In this use uphill and downhill, the tread of a tire has a mechanical operation with an imposed force.

When operating on a bend, during the loading/unloading manoeuvres, illustrated in FIG. 4B, the turn radius during the manoeuvring is, by way of example, between 7 m and 12 m. In this use in a bend, the tread of a tire has a mechanical operation with an imposed deformation.

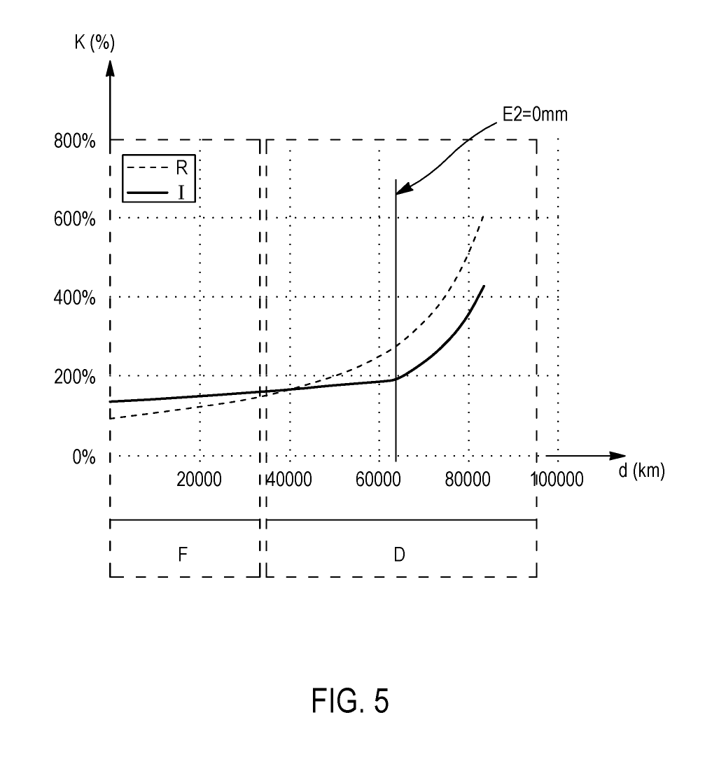

FIG. 5 shows an example of compared change in relative stiffness K, expressed in %, of the tread, between a tire of the prior art R and a tire according to the invention I, as a function of the distance d covered, expressed in km, firstly on a front axle in a “front” position (F), and then secondly on a rear axle in a “drive” position (D). The base 100 for the relative stiffnesses of the tread is the stiffness of the tread of the tire of the prior art R when new, namely having covered 0 km. In the example given, for use in the “front” position, up to a distance of around 35,000 km, the relative stiffness K of the tread of the tire according to the invention I remains higher than that of the tread of the tire of the prior art R. Since the tire preferably operates with imposed force in this low-distance domain, at the start of life, increasing the relative stiffness K of the tread makes it possible to limit the slip rate and the amount of cornering sideslip, and therefore to limit the loss of tread mass through wear. Then, for use in the “drive” position, the relative positioning is switched over: the relative stiffness K of the tread of the tire according to the invention I becomes less than that of the tread of the tire of the prior art R. At the end of life, because of the very high stress loadings experienced during manoeuvres with a tight turn radius, the tire essentially operates with an imposed deformation, and a lower relative stiffness K of the tread makes it possible to reduce the stresses applied to the elastomer compound in contact with the ground and therefore to reduce the loss of tread mass through wear.

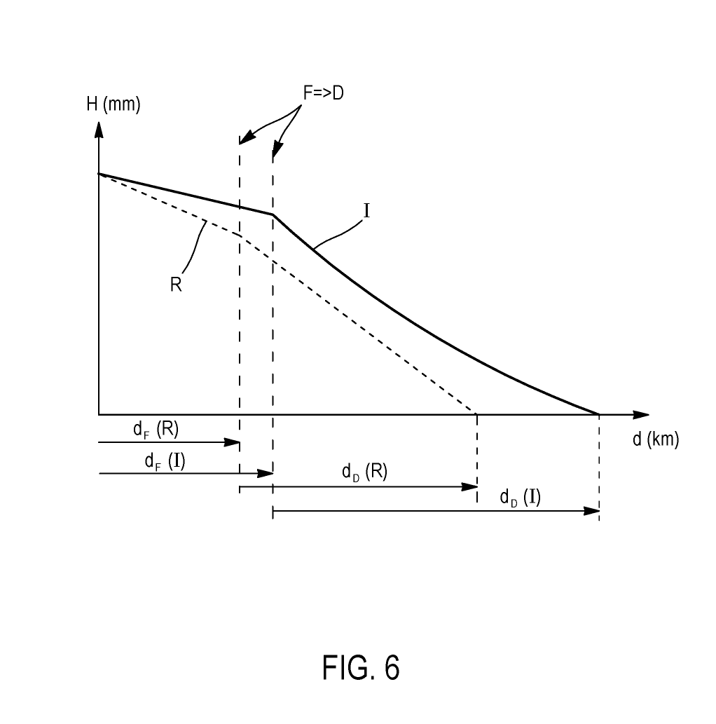

FIG. 6 shows the way in which the height H, in mm, of the tread pattern changes with the distance d covered, in km. The tread pattern is made up of a collection of raised elements or blocks, separated by voids or grooves and constituting the wearing part of the tread. The height H, which indicates the state of wear of the tread, decreases with the distance d travelled. FIG. 6 depicts two typical wear curves for a tire according to the invention I and for a tire of the prior art R, respectively. Each curve comprises two substantially linear portions. The first portion, of shallowest gradient, indicates the wearing of the tire mounted at the front of the vehicle, for the short distances covered. The second portion, of steeper gradient, indicates the wearing of the tire mounted at the rear of the vehicle, for the long distances covered. The change in slope of each curve corresponds to the distance at which the tire was switched between the “front” position and the “rear” or “drive” position. Thus, the distances d_{F}(R) and d_{F}(I), abscissa values for the points at which the slope changes, represent the distances covered on the front axle in the “front” position for a tire of the prior art R and for a tire according to the invention I, respectively. Similarly, the distances d_{D}(R) and d_{D}(I), corresponding to the total tire wear, represent the distances covered on the rear axle in the “drive” position for a tire of the prior art R and for a tire according to the invention I, respectively. It should be noted that the height H of the tread pattern decreases less rapidly, namely that the wear rate is lower, both in the “front” position and in the “drive” position for a tire according to the invention I. In other words, the distances covered respectively on the front axle, before the changeover to the rear axle, and on the rear axle, before the tire is removed for being completely worn away, are higher in the case of the tire according to the invention I.

The invention was studied more particularly in the case of a tire of size 40.00R57, fitted to a rigid dumper with a total laden weight of 400 tonnes.

A bilayer tread according to the invention, made up of a radially interior monolayer first portion 21 having a radial thickness E₁ equal to 30 mm and made of an elastomeric material M₁ of which the dynamic shear modulus G₁, measured for a frequency equal to 10 Hz, a deformation equal to 50% of the peak-to-peak deformation amplitude and a temperature equal to 60° C., is equal to 1.16 MPa, and of a radially exterior monolayer second portion 22 having a radial thickness E₂ equal to 10 mm and made of an elastomeric material M₂ of which the dynamic shear modulus G₂, measured for a frequency equal to 10 Hz, a deformation equal to 50% of the peak-to-peak deformation amplitude and a temperature equal to 60° C., is equal to 1.85 MPa, was assessed for wear, on ground of mining type under imposed force usage and compared against a monolayer tread made up of a single layer having a radial thickness E₀ equal to 40 mm and made of an elastomeric material M₂.

Although the bilayer tread has a stiffness equal to 75% of the stiffness of the monolayer tread, which might suggest a sharp degradation in terms of wearing performance, of the order of 20 to 30%, through an increase in the rate of slip, the change to the local operating point of the radially exterior surface layer 22, thanks to the cushioning effect of the radially interior layer 21, ultimately makes it possible to obtain performance in terms of wear that is equal to or even better than that of the reference monolayer tread.

However, the invention is not restricted to the features described hereinabove and may be extended to other types of tread, for example with different multilayer structures according to the axial portions of the tread.

1. A tire for a heavy vehicle of civil engineering type comprising a tread, adapted to come into contact with the ground,
the tread having an axial width L, and being comprised of a radial superposition of a first portion and of a second portion radially on the outside of the first portion,
the first portion being comprised of a radial superposition of N layers C₁ᵢ, i varying from 1 to N,
each layer C₁ᵢ having a radial thickness E₁ᵢ, measured in an equatorial plane of the tire, that is substantially constant over at least 80% of the axial width L of the tread, and being comprised of a polymer material M₁ᵢ having a dynamic shear modulus G₁ᵢ, measured for a frequency equal to 10 Hz, a deformation equal to 50% of the peak-to-peak deformation amplitude and a temperature equal to 60° C.,
the second portion being comprised of a single layer C₂,
the layer C₂ having a radial thickness E₂, measured in the equatorial plane of the tire, that is substantially constant over at least 80% of the axial width L of the tread, and being comprised of a polymer material M₂ having a dynamic shear modulus G₂, measured for a frequency equal to 10 Hz, a deformation equal to 50% of the peak-to-peak deformation amplitude and a temperature equal to 60° C., wherein the following relationships are simultaneously satisfied:
1/(E₁/G₁+E₂/G₂)>G₀/(E₁+E₂), where E₁=ρᵢ₌₁^{N}E₁ᵢ, G₁=E₁/(Σi=1^{N}E₁ᵢ/G₁ᵢ) where E₁ᵢ, E₁, E₂ in mm, G₁ᵢ, G₁, G₂ in MPa and where 1 MPa≤G₀≤1.8 MPa a.
G₁<G₀ b.
E₁≥E₁min=25 mm c.
G₂>G₀>G₁ d.
E₂≤E₂max=70 mm e.
1/(Σᵢ₌₁^{j}E₁ᵢ/G₁ᵢ)<1/(Σᵢ₌ⱼ₊₁^{N}E₁ᵢ/G₁ᵢ) for 1≤j≤N-1 f.

2. The tire for a heavy vehicle of civil engineering type according to claim 1, wherein the relationship G₁>0.5*G₀ is satisfied.

3. The tire for a heavy vehicle of civil engineering type according to claim 1, wherein the relationship G₂<3*G₁ is satisfied.

4. The tire for a heavy vehicle of civil engineering type according to claim 1, wherein the relationship E₂≤E₂min=25 mm is satisfied.

5. The tire for a heavy vehicle of civil engineering type according to claim 1, wherein the relationship 0.3<E₁/(E₁+E₂)<0.7 is satisfied.

6. The tire for a heavy vehicle of civil engineering type according to claim 1, wherein G₀=1.3 MPa.

7. The tire for a heavy vehicle of civil engineering type according to claim 1, wherein each polymer material M₁ᵢ of which each layer C₁ᵢ of the first portion is made is an elastomer compound.

8. The tire for a heavy vehicle of civil engineering type according to claim 1, wherein the polymer material M₂ of which the layer C₂ of the second portion is made is an elastomer compound.

9. The tire for a heavy vehicle of civil engineering type according to claim 1, wherein the first portion is comprised of a radial superposition of N layers C₁ᵢ, where N is at most equal to 3.

10. The tire for a heavy vehicle of civil engineering type according to claim 1, wherein the first portion is comprised of a single layer C₁.
